(19) United States
(12) Patent Application Publication
(10) Pub. No.: US 2026/0227572 A1
(43) Pub. Date: Aug. 6, 2026

(54) OPTICAL BUS COMPRISING A PLANAR WAVEGUIDE

(71) Applicant: YEDA RESEARCH AND DEVELOPMENT CO. LTD., Rehovot (IL)

(72) Inventor: Ulf LEONHARDT, Tel Aviv (IL)

(73) Assignee: YEDA RESEARCH AND DEVELOPMENT CO. LTD., Rehovot (IL)

(21) Appl. No.: 19/153,352

(22) PCT Filed: Feb. 22, 2024
(86) PCT No.: PCT/IL2024/050201

§ 371 Date: Aug. 4, 2025

(30) Foreign Application Priority Data
Feb. 22, 2023 (IL) 300885

(51) Int. Cl. G02B 6/28; G02B 6/02; G02B 6/12; G02B 6/122; G02B 6/42; G02B 6/43

(52) U.S. Cl. CPC G02B 6/28; G02B 6/02042; G02B 6/12004; G02B 6/122; G02B 6/4214; G02B 6/43; G02B 2006/12061; G02B 2006/12104

(57) ABSTRACT

Provided herein are planar waveguides comprising a plurality of unit cells (81) or an array of unit cells which have a particular refractive index profile. This grid of unit cells, together with a reflecting structure (93) enables light to be reflected and redirected along a path within the waveguide. An optical bus is provided for multi-core processing. Methods of fabricating an array of unit cells for a planar waveguide involving depositing photoresist and thermal oxidation are also provided.

### FIELD OF THE INVENTION

The present invention is directed towards optical buses, multi-cores processors comprising optical buses and planar waveguides comprising a plurality of unit cells or an array of unit cells which have a particular refractive index profile. This array of unit cells, together with a reflecting structure enables light to be reflected and redirected along a path within the waveguide. An optical bus is provided for multi-core processing.

### BACKGROUND

The exponential increase in computational power over the last few decades is running into a bottle-neck—the only way of getting more computing power per chip is to integrate multiple-cores, but the problem with multiple-cores is the complex wiring system, used for inter-core communication. The presently disclosed subject matter replaces wires and fibers altogether, by an appropriately designed integrated optical chip layer that serves the same purpose with less complexity. It eliminates the use of wires thus saving valuable space, reducing power consumption and subsequently internal heat production. It further allows for high number of interconnected processors on the same chip and improves inter-core connectivity by 100-1000-fold, ultimately increasing computational power.

With the global race for more compact electronics, chipmakers are constantly seeking for innovative ways to reduce power consumption, component volumes, and heat production. In parallel, technology developments have increased end-user demands for faster and more efficient systems, requiring either increased clock-speed or multi-core processors and subsequent complex inter-core communication. Both alternatives suffer from major drawbacks as increased clock-speed results in higher power consumption and internal heat production, and efficient inter-core communication enabled by complex wire bus systems, takes space, consume energy, and produce excess heat. An alternative to wires is optical fibers, which while reducing the internal heat production are still limited by complex wiring networks and one-dimensional optical data transmission. The stagnant clock rate, growing chip complexity, and the limiting number of integrated core processors, demands a robust inter-core data transmission platform that will be more efficient, less complex, and enable better multicore connectivity.

One aspect of the presently disclosed subject matter provides a single compact on-chip optical layer, compatible with complementary metal-oxide-semiconductor (CMOS) fabrication technologies, that replaces the tangle of wires and fibers.

Advantages of the present application include, but is not limited to: direct and wireless inter-core communication, waveguide fabrication is compatible with traditional CMOS fabrication technologies, scale-up connectivity of processor cores by 100-1000 fold, increased computing power, reduced electric power consumption, reduced heat output, space and energy efficiency and point-to-point communication without crosstalk.

The presently disclosed subject matter is applicable for a full range of markets, integrated electronic technologies including: consumer electronics, automatic car industry, hardware for deep-learning networks, robotics, signal processing, telecommunications and information processing.

### SUMMARY

In one embodiment this invention provides an optical bus comprising:
a planar waveguide comprising a light-propagating layer comprising a plurality of unit cells, wherein the unit cells have a non-uniform refractive index profile;
a set of illumination ports configured to direct light into the light-propagating layer;
a plurality of reflectors configured to change the direction of light propagating in the light-propagating layer at least once; and
a light management system configured to selectively activate one or more illumination ports of a set of light emitters and simultaneously activate one or more illumination ports of a set of photodetectors.

In one embodiment the plurality of unit cells forms an array. In one embodiment the planar waveguide further comprises an upper layer above and a lower layer below the light-propagating layer. In one embodiment the upper layer and the lower layer have a lower refractive index than the refractive index of the light-propagating layer. In one embodiment the light-propagating layer comprises silicon. In one embodiment the upper layer and the lower layer comprise silica. In one embodiment the refractive index profile is the same in each of the unit cells.

In one embodiment the refractive index profile is not the same in each of the unit cells within the array of cells. In one embodiment the refractive index is dictated by the thickness of the light-propagating layer. In one embodiment each unit cell of the plurality of unit cells have a refractive index of between 1.5 and 3.0. In one embodiment the shape of the unit cell is selected from a list comprising: square, rectangle, circle, trapezoid, rhombus, parallelogram, triangle, quadrilateral, pentagon, hexagon, heptagon, octagon, nonagon, decagon or any combination thereof. In one embodiment the plurality of reflectors are Bragg mirrors. In one embodiment the plurality of reflectors form at least two zig-zag shaped reflectors at opposite sides of the planar waveguide and configured to direct light through the plurality of unit cells. In one embodiment the set of illumination ports are positioned within the light-propagating layer. In one embodiment the set of illumination ports is positioned within the upper layer or lower layer, or within the upper layer and the lower layer. In one embodiment the set of illumination ports are configured to focus light emanating from any light port of the set onto a plurality of remaining ports of the set. In one embodiment the size of the unit cell is at least one order of magnitude larger than the wavelength of the light. In one embodiment the light is in the infrared range. In one embodiment the light comprises more than one frequency transmission.

In one embodiment the invention provides a system connecting multi-core processors, the system comprising:
a plurality of multi-core processors, wherein each multi-core processor comprises a plurality of core processors; and
the optical bus described herein, configured to transmit optical signals between said plurality of multi-core processors.

In one embodiments the system further comprises:
a first set of transceivers corresponding with each multi-core processor, configured to convert electrical signals from respective multi-core processors into optical signals for transmission via the optical bus; and
a second set of transceivers corresponding with each multi-core processor, configured to convert optical signals received from the optical bus into electrical signals for communication to the respective multi-core processors.

In one embodiment the system further comprises at least one controller configured to manage data traffic via the optical bus.

In one embodiment the invention provides a multi-core processor comprising:
a plurality of core processors; and
the optical bus of the present invention.

In one embodiment the invention provides a method of fabricating an array of unit cells for a planar waveguide, the method comprising:
providing a substrate comprising a first layer comprising silicon oxide, a second layer comprising silicon and third layer comprising silicon oxide;
depositing a photoresist onto the third layer;
patterning the photoresist, producing a patterned photoresist array on the third layer wherein a plurality of regions of the third layer are not covered by the photoresist;
etching the substrate, producing a plurality of thin regions of the third layer corresponding to the plurality of regions that were not covered by the photoresist;
removing the photoresist; and
carrying out thermal oxidation of the substrate wherein the oxidation of the second layer is greater below the plurality of thin regions of the third layer, producing an array of unit cells in the second layer with a varied height profile.

In one embodiment the third layer is produced by thermal oxidation. In one embodiment the patterning is carried out by light exposure through a photolithography mask. In one embodiment the patterning is carried out by light exposure by direct laser writing. In one embodiment the patterning is carried out by electron beam lithography. In one embodiment the method further comprises cladding or encapsulation of the planar waveguide.

In one embodiment the invention provides a method of fabricating an array of unit cells for a planar waveguide, the method comprising:
providing a substrate comprising a first layer comprising silicon oxide and a second layer comprising silicon;
depositing a photoresist onto the second layer;
providing a grayscale photolithography mask and patterning the photoresist, producing a grayscale-patterned photoresist array of non-uniform thickness;
carrying out thermal oxidation of the substrate wherein the oxidation of the second layer is greater below thinner regions of the grayscale-patterned photoresist, producing an array of unit cells in the second layer with a varied height profile; and
removing the photoresist.

In one embodiment the method further comprises cladding or encapsulation of the planar waveguide.

In one embodiment the invention provides a method of operating a system connecting multi-core processors, the method comprising:
providing the system connecting multi-core processors of present invention;
operating the light-management system for the transmission of light from a port of one core processor in a plurality of core processors, which is received at the ports of other core processors in the plurality of core processors;
the transmission of light comprises a sequence of light pulses that the planar waveguide directs to the ports of other core processors; and
the light management system converts the sequence of light pulses into electric signals.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a combined graphic and schematic depiction of effective refractive index as a function of height of the propagation layer of the planar wavelength.

FIG. 2 is a schematic cross-sectional view of the optical bus.

FIG. 3 is a schematic top view of a propagation layer of the optical bus depicting light propagation from a divergence point to convergence at multiple focal points for a circular embodiment of the optical bus.

FIG. 4 is a schematic top view of a propagation layer of the optical bus depicting light propagation from a divergence point to convergence at multiple focal points for a square embodiment of the optical bus.

FIG. 5 is a schematic top view of a propagation layer of the optical bus depicting spiral light propagation from a divergence point to convergence at multiple focal points for an embodiment of the optical bus.

FIG. 6 is a schematic top perspective view of the optical bus depicting illumination port arrays dedicated to multiple core processors.

FIG. 7 is a graphical simulation depicting a refractive index profile for an individual unit cell.

FIG. 8 is a schematic representation of connected unit cells coupled with mirrors, configured to change the direction of light propagation. FIG. 8A shows light being reflected in one direction after being incident on a mirror. FIGS. 8B and 8C show light being reflected in two directions by mirrors.

FIGS. 9A-9F depict the progressive construction of a planar waveguide, comprising a plurality of unit cells, directing light along a particular path using a plurality of reflectors. FIG. 9A shows the light path in a planar waveguide constructed of unit cells and two reflectors positioned to change the direction of light propagation. From FIGS. 9A to 9F a reflector is added, showing how the light path changes with the addition of reflectors.

FIG. 10A shows a rectangular grid of cells with a refractive index profile (greyscale). The black zig-zag line depicts perfect mirrors where the field vanishes. The remaining boundary of the medium (to the right and left) are open to escaping radiation. FIG. 10B shows light rays propagating in the refractive index profile of FIG. 10A.

FIG. 11 shows a schematic representation of a thermal oxidation process that does not expose the light-propagating layer to etching and wherein an array of unit cells is fabricated. FIG. 11A shows the initial silicon oxide, silicon, silicon oxide layered substrate. FIG. 11B shows the patterned and subsequently etched array in the upper oxide layer. FIG. 11C shows the remaining planar waveguide array structure after thermal oxidation of the layered structure of FIG. 11B.

FIG. 12 shows a schematic representation of grayscale photolithography to generate an array of unit cells, forming a planar waveguide. FIG. 12A shows the step of light exposure through a grayscale photomask. FIG. 12B shows a patterned photoresist following grayscale exposure and post-development. FIG. 12C shows the final array of unit cells in a planar waveguide.

For simplicity and clarity of illustration, elements shown in the figures are not necessarily drawn to scale, and the dimensions of some elements may be exaggerated relative to other elements. Figures are provided as illustrations of various embodiments provided herein but are non-limiting. In addition, reference numerals may be repeated among the figures to indicate corresponding or analogous elements.

### DETAILED DESCRIPTION

The present invention is generally directed towards optical data communication, and specifically, is directed to scaling up the number of cores that can be effectively employed in a single processor to increase computing power by improving inter-core communication through an optical bus implemented as a planar waveguide. The optical bus advantageously leverages spatial selectivity to optically link thousands of optical emitters and receivers on each core. Consequently, the number of transmission channels available in the bus is limited by the area available in the focusing region of the propagation layer of the waveguide to receive illumination ports.

The following terms will be used throughout.

As referred to herein an “optical bus” is a communication system that uses light to transmit data between devices or other systems, typically through an optical medium. In optical communication technology optical buses describe a network architecture that uses multiple optical systems or transmission paths to carry data. In some embodiments, optical buses refer to processor cores or a plurality of processor cores which are optically connected to one another. “Optically connected” refers to any transmission or receiving of a signal between one unit and another unit e.g., between processors or a plurality of processors. In some instances the terms “connected” and “coupled” are used interchangeably.

“Illumination port” or “port” refers to dual function micro-diodes that can be activated as either a Light Emitting Diode (LED) or photodiode depending on the direction of a voltaic bias applied. The term “photodetector” refers to a “photodiode”. In some embodiments the terms “photodetector”, “detector” “light receiver” and “receiver” are interchangeable. A port can thus be referred to as a “receiving port” if it receives a signal, or an “illumination”, “emission” or “transmission” port if it transmits a signal. In some embodiments, ports can either transmit or receive signals. In other embodiments, ports can simultaneously transmit and receive signals. As such, the term “port” generally refers to ports being able to receive and transmit signals in any manner e.g., sequentially and/or simultaneously.

“Port set” refers to a set of ports disposed at focal points of the propagation layer.

“Focusing region” refers to a region in the propagation layer satisfying the condition in which multiple light rays emitted at any point in this region are focused at corresponding points within the focusing region. The geometry of the thickness profile in which this condition is satisfied is a function of the embodiment, several non-limiting embodiments as set forth herein.

As noted above, the optical bus is implemented as a planar waveguide and is constructed from alternating of layers of relatively high and low refractive-index materials in which the low index materials sandwich the higher index material. Without diminishing in scope, the presently disclosed subject matter discloses embodiments employing a silica-silicon-silica sandwich.

As is known in the art, light propagation through such a waveguide is confined to the high-index layer through total internal refraction and is therefore deemed the propagation layer and the silica layers are deemed to be the non-propagation layers.

As noted above, the optical bus is implemented as a planar waveguide and is constructed from alternating of layers of relatively high and low refractive-index materials in which the low index materials sandwich the higher index material. Without diminishing in scope, the present disclosure will provide embodiments employing a silica-silicon-silica sandwich.

### Ring- and Square-Based Waveguides

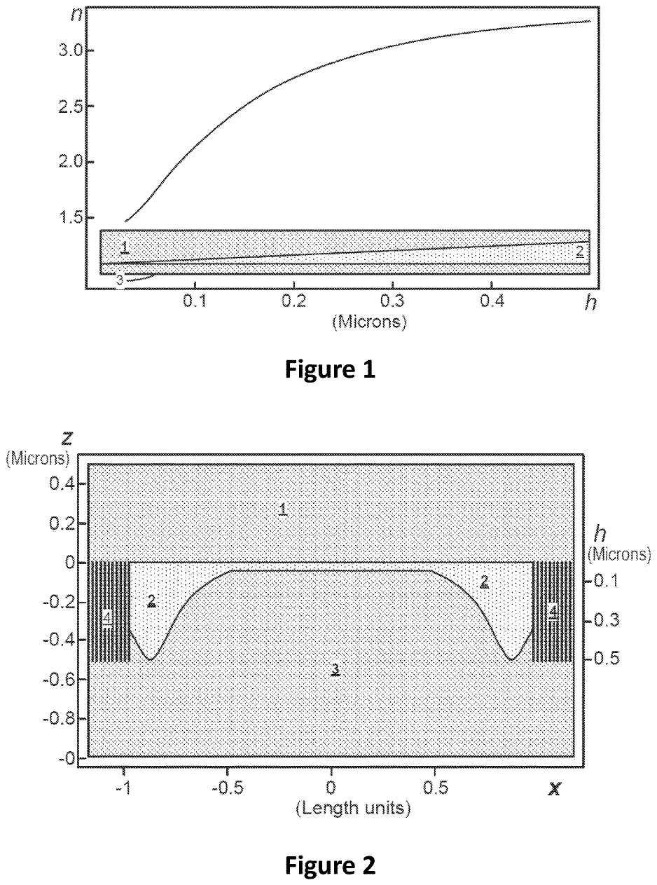

The propagation layer of the instant planar waveguide exhibits a variable effective refractive-index n that changes as a function of height h or thickness of the silicon propagation layer, which is depicted schematically and graphically in FIG. 1. The effective refractive-index n of the silicon propagation layer is shown for light having a free space wavelength λ=1.55 μm and assumes an infinite thickness of the silica layers. Such an assumption is justifiable because the electromagnetic field exponentially decreases as a function of silica thickness.

The effective refractive-index n is obtained by solving for the ground state of the Helmholtz equation for the polarization with electric field orthogonal to the propagation layer. Standard Sellmeier equations are used for the individual refractive indices of silica (glass), n_{g}, and silicon nₛ, respectively. The effective refractive-index n of a sandwich of silica, silicon, silica where the silicon propagation layer has variable height h in μm is given by the following mathematical procedure in which the electric field in the various layers is set forth as Equation (1):

$${E}_{1} = {a}_{1} exp ( \sqrt{{β}^{2} - {n}_{g}^{2} {k}^{2}} z ) in lower silica layer 1 ,$$

$${E}_{2} = cos ( \sqrt{{n}_{s}^{2} {k}^{2} z - {β}^{2}} z ) + {a}_{2} sin ( \sqrt{{n}_{s}^{2} {k}^{2} z - {β}^{2}} z ) in silicon layer , 2 , and$$

$${E}_{3} = exp ( - \sqrt{{β}^{2} - {n}_{g}^{2} {k}^{2}} z ) in upper silica layer , 3 ;$$

where k=2π/λ for light with free-space wavelength λ. Require E₁=E₂, ∂E₁/∂z=∂E₂/∂z at z=−h/2 and E₂=E₃, ∂E₂/∂z=∂E₃/∂z at z=h/2, and solve numerically with a computing device for aₘ and β. The effective refractive-index is then given by n=β/k. The function n(h) in FIG. 1 is numerically inverted to give h(n).

FIG. 2 depicts a cross-sectional view of an embodiment of an optical bus having light-propagation layer 2, lower and upper non-propagation layers 1 and 3, respectively and a Bragg mirror 4 surrounding the propagation layer 2 and a portion of lower non-propagation layer 3. As shown, light-propagation layer 2 is rotationally symmetric and has a varying height h in microns defining an effective refractive profile in accordance with Cartesian coordinates x and y identifying lateral position on the propagation layer. This view is shown for a cut at y=0 along the diameter of the device and it should be appreciated that height units are different than the lateral length units (x and y); the height relative to the depicted length is exaggerated for the sake of clarity.

The effective index profile is designed to enable light emission at one point in the optical bus to be focused at multiple, exclusive partner points, thereby advantageously enabling reliable information transfer through encoded light when deployed.

This index profile is generated in accordance with Equation (2):

$$n = {n}_{0} \frac{2 {r}^{\frac{m}{2} - 1}}{1 + {r}^{m}} \qquad ( 2 )$$

where the radius r=\sqrt{x²+y²} is given in units of the radius of the device, m denotes the number of optically connected light ports and no is an arbitrary constant pre-factor. As shown in FIG. 2, the profile generated from Equation (2) flattens out in the locations in which the refractive index drops from its maximal value by a factor of two, in a certain embodiment. The pre-factor is chosen such that this range of n lies within the range of refractive index depicted in FIG. 1.

Equation (2) is obtained from the index profile of Maxwell's fish eye through optical conformal mapping with a power-law conformal transformation in accordance with the article “Optical Conformal Mapping” and “Perfect imaging without negative refraction” by U. Leonhardt, Science 312, 1777 (2006) and U. Leonhardt, New J. Phys. 11, 093040 (2009). Both articles are hereby incorporated by reference in their entirety. The power-law conformal transformation is described by the analytic function w=z^{m/2} of z=x+iy.

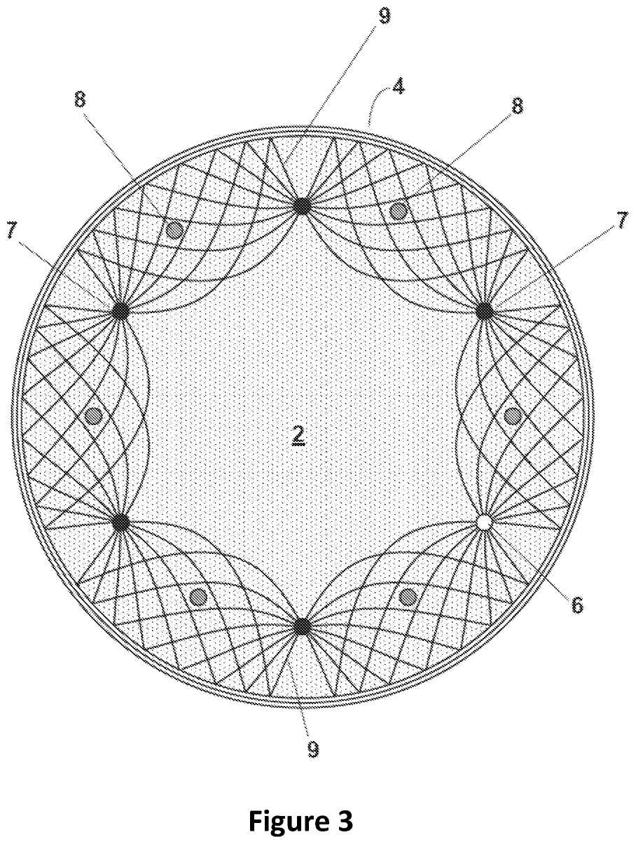

FIG. 3 is a schematic, top view of light propagation in propagation layer 2 of a circular optical bus, having, an active set of focal points and a selectable light emission point 6 and receiving focal points 7 plus inactive focal points 8, and a circumferential Bragg mirror 4, according to an embodiment.

In operation, the effective refractive index defined by the thickness profile depicted in FIG. 2 causes light propagation to follow specific propagation paths 9 having a unique and exclusive set of focal points. Light emitted at any one of these focal points propagates as shown and converges at each of the partner focal points of the focal point set without converging at focal points associated with inactive focal point sets for emission point 6. It should be appreciated that in operation multiple sets of focal points are employed simultaneously and each light emission is confined to its respective set of focal points.

Shown is an example of light divergence at its emission point 6, travel along propagation path 9, and convergence at multiple focal points 7 without converging at focal points 8 associated with other focal point sets.

Ray tracing in propagation layer 2 is achieved through numerically solving Hamilton's equations for the position vector r and wave vector k of the light rays in Equation (3):

$$\frac{dr}{dt} = \frac{\partial ω}{\partial k} , \frac{\partial k}{dt} = - \frac{\partial ω}{\partial r} , with ω = \frac{\vert k \vert}{n} \qquad ( 3 )$$

Light generally refers to infrared light because of its outstanding propagation properties in silicon; however, various other wavelengths useful in such applications can also be employed.

Bragg mirror 4 is configured to ensure that light emission escaping the propagation layer 2 is reflected to ensure complete internal reflection in accordance with the propagation path discussed above and depicted in FIG. 3.

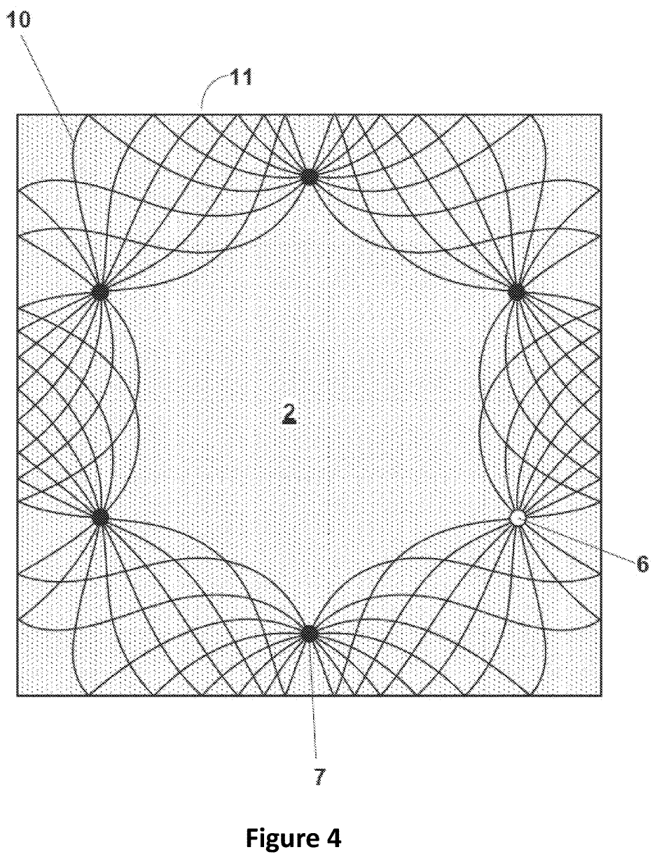

FIG. 4 is a schematic, top view of light propagation in propagation layer 2 implemented in a rectangular optical bus for applications requiring such bus geometry to match the geometry of computer processors or the geometry of the core layout.

Analogously to the circular embodiment of FIG. 3, this embodiment also has an active set of focal points having a selectable emission point 6 and receiving focal points 7, plus an inactive set of focal points (not shown), and a circumferential mirror 11, according to an embodiment.

In operation, the effective refractive index defined by the thickness profile causes light propagation to follow propagation path 10 having a unique and exclusive set of focal points different that the path depicted in the circular embodiment of FIG. 3.

The necessary effective refractive index is implemented, here too, through the thickness profile of propagation layer 2 as set forth above through Equation (1). The effective refractive index profile for this rectangular embodiment is derived through conformal transformation of Equation (2) of the circular embodiment depicted in FIG. 3 to maintain light propagation functionality.

The conformal transformations can be implemented by refractive index profiles calculated in accordance with the above-noted article “Optical Conformal Mapping” in Science 312, 1777 (2006). Specifically, the transformation of a unit disk to a unit square is given by Equation (4):

$$z = ( I - 1 ) ( \frac{F ( ar cos ( \sqrt{i} w ) , \frac{1}{2} )}{K ( \frac{1}{2} )} - 1 ) \qquad ( 4 )$$

where w=u+iv are re-named Cartesian coordinates of the plane of FIG. 3 in complex notation (and in units of the radius) and z=x+iy are the corresponding Cartesian coordinates of FIG. 4 in units of a processor size; F is the elliptical integral of the first kind and K is the complete elliptical integral of the first kind.

The transformed effective refractive index profile n′ is given, in terms of the original profile n and the conformal transformation, by the Equation (5)

$${n}^{′} = n \vert \frac{dw}{dz} \vert \qquad ( 5 )$$

where n should be taken as a function of w(z) and w*(z*), and the conformal transformation is represented by the analytic function w(z) on the complex plane; the inverse of z(w).

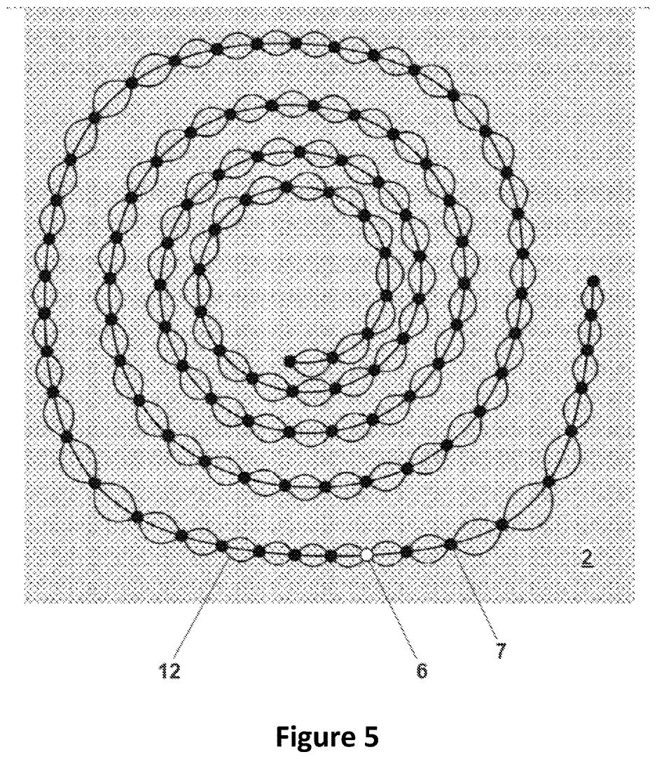

FIG. 5 is a schematic, top view of light propagation in an alternative embodiment of propagation layer 2 having 107 optically-connected, focal points. Analogously, to the embodiments previously depicted, light from any selectable light emission point 6 converges on all remaining 106 focal points 7. As noted above, additional focal point sets emit and receive light simultaneously and independently to the active focal point set depicted with an emitter and a receiver. It should be appreciated that this embodiment does not employ a peripheral mirror.

This lighting configuration is based on Mikaelian's lens [A. L. Mikaelian and A. M. Prokhorov Prog. Opt. 17, 279 (1980)] with an effective refractive index profile given by Equation (6):

$${n}_{M} = {n}_{0} sech ( Y / b ) \qquad ( 6 )$$

in an {X, Y} plane to be transformed by optical conformal mapping to physical coordinates; b is a scaling parameter and no an arbitrary constant to be determined by the refractive-index range depicted in FIG. 1 This profile is used until n_{M} drops by ½ from its maximum (until Y=b arcosh2).

With conformal transformations, the strip of Mikaelian's lens defined in Equation (6) is mapped to the substantially spiral shape shown in FIG. 5. The transformations are w=(X+iY)^{a} with complex a (here a=1+20i), divided by a re-scaling constant R (here R=10) followed by the transformation of Eq. (4).

Using Eq. (5) for the total transformation the effective refractive-index profile of the transformed Mikaelian's lens is calculated; the space between the transformed strip wrapped to a spiral shape is smoothly interpolated. The ray tracing is performed with the method of Eq. (3).

It should be appreciated that many possible light propagation geometries exist that provide optically-connected focal group sets enabling emission at any focal point and light convergence at all remaining focal points.

Furthermore, in a certain embodiments the propagation layer 2 is divided by an additional non-propagation layer to form a five-layer planar waveguide. Thickness profile of the two propagation layers is determined by extending the methods described here within as is known to those skilled in the art.

In yet another embodiment, employing only two non-propagation layers, each is implemented with a different refract index from that of each other.

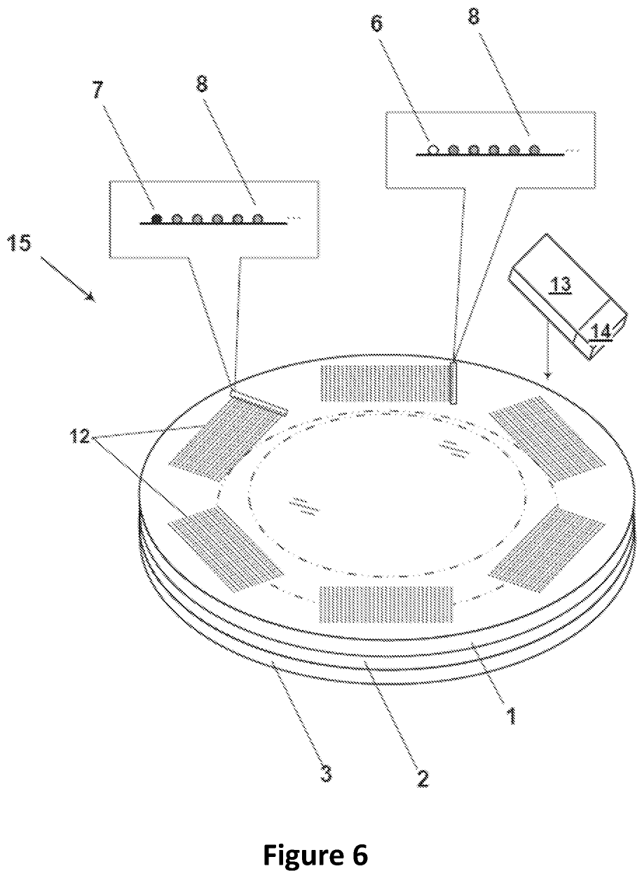

FIG. 6 is a schematic, expanded top-view of the planar wave guide depicted in FIGS. 1-3 implemented as an optical bus 15 and one processor 13, according to an embodiment.

As shown, optical bus 15 optically connects six processor cores 13 (Only one shown for the sake of clarity.) through six illumination port arrays 12; each array dedicated to its respective processor core 13.

Each illumination port of each array 12 is a member of its own port set and is embedded into propagation layer 2 at each focal point or embedded into one of non-propagation layers 1 or 3 and directed to the focal points in propagation layer 2 in another embodiment.

Also for the sake of clarity, only one emitter 6 and one detector 7 are depicted as activated ports. It should be appreciated that inactive ports 8 are only inactive relative to the active ports depicted; emitter 6 and receiver 7. Depicted inactive ports 8 are indeed active as a member of their own respective port set and operate simultaneously with depicted active ports 6 and 7.

Each of the illumination ports of array 12 is implemented as dual-function illumination port that operates either as a light emitter or a light detector depending on the voltaic bias applied, as noted above. When the optically active structure of the illumination port is forward biased, it functions as a LED and when reverse biased, it acts a photodetector.

In a certain embodiment, the optical active structure has a diameter of about 20 μm, in other embodiments the diameter is less than 20 μm. Further details regarding the construction and operation of the illumination ports is found in U.S. Pat. No. 6,410,940, and is hereby incorporated by reference in its entirety.

In certain embodiment, a first set of ports operate at a first wavelength and a second set of ports at a different wavelength.

Biasing is managed by a light management system 14 of switching electronics disposed in one or more of the cores 13, other processing units, or both; depending on the embodiment. Light management system 14 is in communication with processor core circuitry and is operative in accordance with data transmission requirements between the cores. Temporal data is optically transmitted from any one of the illumination ports activated as light emitter 6 and received by corresponding ports activated as photodetectors 7 associated with other cores as guaranteed by the design of propagation layer 2.

Since each array 12 is formed from one illumination port from each respective port set, the number of ports in each array represents the number of discrete, data transmission paths available for optical data transmission

The low-high-low index materials for the planar waveguide can be constructed through photolithography and the deposition of the appropriate material as is known in the art. Alternatively, the planar waveguide may be constructed through controlled oxidation in the absence of etching as set forth in the article “Low Loss Etchless Silicon Photonic Waveguides” by J. Cardenas, C. B. Poitras, J. T. Robinson, K. Preston, L. Chen, and Lipson, Opt. Express 17, 4752 (2009) available at https://doi.org/10.1364/OE.17.004752 and is hereby incorporated by reference in its entirety.

The optical bus advantageously increases data transfer rate between cores by a factor of 1000. Furthermore, better connectivity between processor cores can increase computational power, reduce power consumption, and increase battery life of mobile devices.

### Planar Waveguides—Multiple Focusing by Transformation Optics

The present invention, designed by transformation optics, involves a compact optical bus, comprised of a planar waveguide on silicon chips where light is confined in a layer by total internal reflection. In one embodiment, the layer is made of silicon that has a high refractive index, sandwiched between layers of silica (glass) with a much lower index. The height of the highly refractive layer is carefully designed to provide a specific refractive index profile, dictated by the layer thickness. A light management system selectively activates specific illumination ports embedded within the waveguide; the emanating light is then focused onto reflectors, or Bragg mirrors, which lead to light ray emission at specific partner points. In a similar manner, the light can be simultaneously focused onto a plurality of photodetectors within the waveguide, each of which communicates with a separate processor core. Bus geometry can be adjusted to match computer processor or core layout requirements. In some embodiments the terms “bus” and “optical bus” are used interchangeably.

In the broadest sense a “waveguide” is a structure that guides waves, such as electromagnetic waves, with minimal loss of energy by restricting the transmission of energy to one direction. The present invention not only provides linear and planar waveguides, but also waveguides that change the direction of light when used in combination with reflectors. In one embodiment, the direction of light is changed within the waveguide however light-propagation remains within one plane. As such the waveguide is referred to as a “planar waveguide”. However, “waveguide” and “planar waveguide” are used interchangeably, in some embodiments.

For example, the power consumption drops by a factor of eight if the core activity increases by a factor of two due to better connectivity, assuming the same computational power. The activity is the average number of active cores divided by the total number of cores. This means that the battery of a mobile device lasts nearly 10 times longer. The reason for the dramatic effect on the battery life is that the power consumption depends cubically on the clock speed; distributing a computational task among several cores allows reducing the clock speed and therefore the power consumption by the cube of the increased activity.

The present invention is directed towards optical buses comprising planar waveguides comprising a plurality of unit cells or an array or grid of unit cells which have a particular refractive index profile. This grid of cells, together with a reflecting structure enables light to be reflected and redirected along a path within the waveguide.

### A Unit Cell

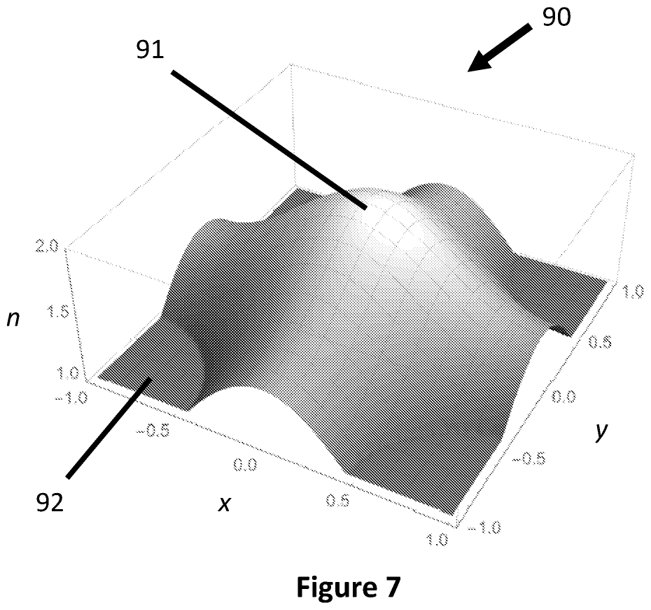

In one embodiment the array of the present invention is comprised of a plurality of unit cells 90 as shown in FIG. 7. In another embodiment the unit cells form an array or grid. In another embodiment the unit cells 90 are flush and pack in a tight grid i.e., there are no gaps in between the unit cells 90. The unit cells 90 can be any shape to form a tiling. In one embodiment unit cells are tessellated. In one embodiment the individual unit cells are 2-dimensional. In other embodiments the unit cells are 3-dimensional. In one embodiment, the shape of an individual cells 90 is selected from: square, rectangle, circle, trapezoid, rhombus, parallelogram, triangle, quadrilateral, pentagon, hexagon, heptagon, octagon, nonagon, decagon or any combination thereof. In one embodiment, the shape of an individual cells 90 is a polygon. As used herein the term “single cell”, “unit cell”, “individual cell”, “cell” or “light-propagation layer” can be used interchangeably. In one embodiment the unit cell is a Maxwell fisheye. In another embodiment the unit cell is a square Maxwell fisheye.

As disclosed, each cell has a refractive index profile. In some embodiments, as used herein, the terms “refractive index”, “effective refractive index” and “index” are used interchangeably. The refractive index of each cell is not uniform, namely it is varies across each individual cell (see FIG. 7, for example). As such, although each unit cell is of a particular shape, the refractive index profile does not necessarily linearly correlate with the refractive index. For example, a unit cell with a square shape can have a circular-shaped refractive index profile. In one embodiment the refractive index profile is represented by a non-linear function. In one embodiment the refractive index profile is represented by a high-order non-linear function. In one non-limiting example, the unit cell 90 has the highest refractive index in its center 91 and a lower value (shown as 1.0) at each of the four edges 92 in the unit cell. In some embodiments unit cells are arranged together to propagate light in a particular direction.

In one embodiment the refractive index range within a unit cell is between 0.01 to 1.0. In one embodiment the refractive index range within a unit cell is between 0.01 to 0.5. In one embodiment the refractive index range within a unit cell is between 0.5 to 1.0. In one embodiment the refractive index range within a unit cell is between 1.0 to 2.5. In one embodiment the refractive index range within a unit cell is between 1.0 to 2.0. In one embodiment the refractive index range within a unit cell is between 1.0 to 1.5. In one embodiment the refractive index range within a unit cell is between 1.5 to 2.0. In one embodiment the refractive index range within a unit cell is between 1.5 to 3.0. In one embodiment the refractive index range within a unit cell is between 2.0 to 3.0. In one embodiment the absolute value of the refractive index within a unit cell is between 1.0 to 3.0. In one embodiment the absolute value of the refractive index within a unit cell is between 1.5 to 3.

How two or more unit cells are connected is determined by the direction in which the light is chosen to propagate. Indeed, a plurality of connected unit cells, together with a plurality of reflectors can be used to direct light propagation in any specific direction, as will be disclosed herein.

Gradient index lenses (GRIN lenses) are optical elements whose refractive index varies within the lens. In one embodiment, the unit cell comprises a GRIN lens. As such, and in some embodiments, the array comprises a plurality of GRIN lenses.

The size of a unit cell can be selected to optimize a particular operation. In some embodiments, the size of all unit cells in an array is identical or about the same. In other embodiments the size of the unit cells comprised within an array differ. As stated herein, the shape of a unit cell is not limited to a square. Several orders of magnitude of the spatial dimensions of the unit cell are considered. Using a 2D square unit cell as an example (e.g., with x and y dimensions or simply “spatial dimensions”), embodiments of the spatial dimensions are as follows: In one embodiment, the spatial dimensions of the unit cell are about 10 to 100 nm. In one embodiment, the spatial dimensions of the unit cell are about 100 to 500 nm. In one embodiment, the spatial dimensions of the unit cell are about 500 to 1000 nm. In one embodiment, the spatial dimensions of the unit cell are about 10 to 1000 nm. In one embodiment, the spatial dimensions of the unit cell are about 1 to 10 μm. In one embodiment, the spatial dimensions of the unit cell are about 1 to 50 μm. In one embodiment, the spatial dimensions of the unit cell are about 1 to 100 μm. In one embodiment, the spatial dimensions of the unit cell are about 50 to 100 μm. In one embodiment, the spatial dimensions of the unit cell are about 100 μm to 1 mm. In one embodiment, the spatial dimensions of the unit cell are about 1 mm to 1 cm. In one embodiment the unit cell is at least one order of magnitude larger than the wavelength of light.

The thickness (also referred to herein as “height”) of the unit cell can be varied to dictate the refractive index. As such, and in one embodiment, the thickness of at least part of the unit cell is in the order of 1 to 100 nm. In one embodiment, the thickness of at least part of the unit cell is in the order of 100 to 1000 nm. In one embodiment, the thickness of at least part of the unit cell is in the order of 1 to 10 μm. In one embodiment, the thickness of at least part of the unit cell is in the order of 10 μm to 1 mm.

A unit cell is comprised of a dielectric material within which light propagates (i.e., light propagating layer); the unit cell being comprised within a planar waveguide. In one embodiment unit cells consist of at least one dielectric material. In one embodiment light propagates in at least one unit cell. In other embodiments light propagates in a plurality of unit cells. In one embodiment the planar waveguide further comprises an upper layer above and a lower layer below the light-propagating layer. This is often referred to as encapsulation or cladding of the light-propagation layer. This arrangement facilitates total internal reflection within the light-propagating layer wherein the light-propagating layer is comprised of a material which has a higher refractive index than that of both the upper and lower layers. Cladding is also utilized to protect elements within a device. In one embodiment the upper and lower layers are comprised of the same material. In other embodiments the upper and lower layers are comprised of different materials. Typically, the light-propagation layer facilitates the transmission of light in the infrared range. An operation frequency is selected according to the material to optimize light and energy transmission within the system and to reduce energy loss; thus a frequency is selected accordingly, in one embodiment. Furthermore, the light frequency will be selected according to the unit cell and array architecture and according to the needs of a particular system and user. For example, small unit cells will require a shorter transmission wavelength than larger unit cells. Furthermore, unit cells of different shapes may be restricted to certain bandwidths, according to the structure of the array and shape of the unit cells; the present invention considers all such combinations.

The flat areas in FIG. 7 represent areas where the refractive index is uniformly equal to 1.0. These flat edges could be considered to limit the aperture of focus. However, considering this structure as a whole, the system is at least one order away from the diffraction limit.

In one embodiment the frequency that the planar waveguide supports comprises at least part of the infrared range. The infrared range is between about 700 nm-1 mm, in one embodiment. In one embodiment the frequency that the planar waveguide supports comprises at least part of the microwave range. The microwave range is between about 1 mm-1 m, in one embodiment. In another embodiment the frequency that the planar waveguide supports comprises the radio frequency range. In one embodiment the frequency that the planar waveguide supports comprises the visible light range.

The planar waveguide supports at least one frequency transmission. In another embodiment, the planar waveguide supports the transmission of more than one frequency transmission. In another embodiment, the planar waveguide supports the transmission of more than one frequency transmission simultaneously. In another embodiment, the planar waveguide supports the transmission of more than one frequency transmission which is partly simultaneous. This means that part of the multiple signals operate simultaneously whereas other parts do not.

In one embodiment the unit-cell comprises silicon. In one embodiment the unit cell consists of silicon. In one embodiment the unit cell comprises doped silicon. In one embodiment the unit cell comprises silicon oxide. In one embodiment the unit cell comprises any of the following materials selected from: silicon oxide, silicon dioxide, silicon, doped-silicon, glass, plastic, polycarbonate, zinc selenide, barium fluoride, potassium bromide, cadmium telluride, gallium arsenide, thallium bromoiodide, lithium fluoride or any combination thereof. In some embodiments the unit cell is comprised of a material that enables infrared transmission. Non-limiting examples of infrared compatible materials for optics include: calcium fluoride, fused silica, silicon-based materials, silicon oxide, germanium, magnesium fluoride, potassium bromide, sapphire, silicon, sodium chloride, zinc selenide and zinc sulfide.

In some embodiments the planar waveguide further comprises an optical coating.

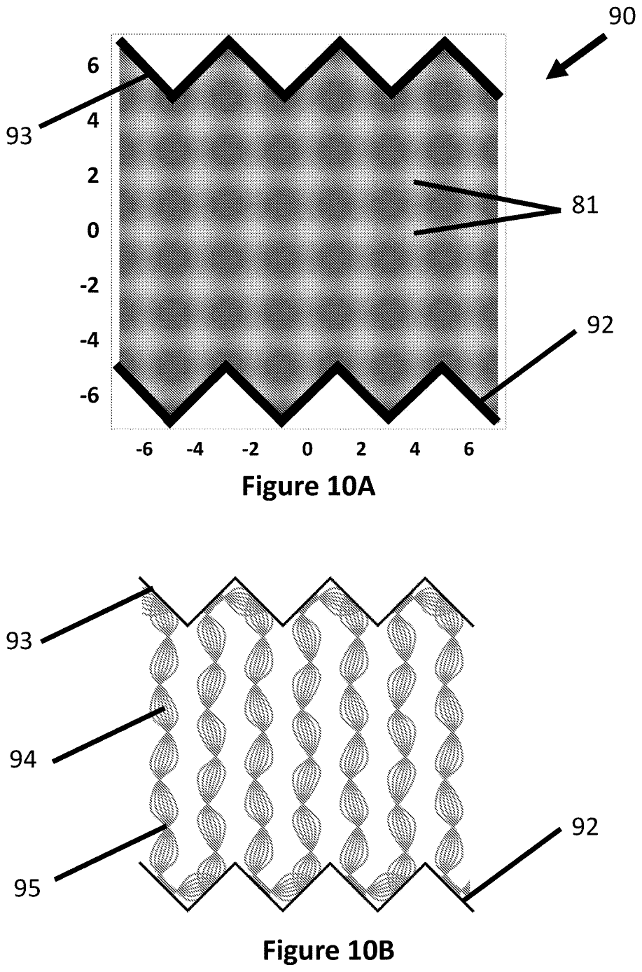

An example of a refractive index profile is shown in FIG. 7. In this figure the refractive index, n, varies from 0.5 n₀ to n₀ (shown as the vertical, z-axis) with x and y axes ranging between −1.0 to +1.0 in arbitrary units. For example: each one of the quadratic cells of the grid of FIG. 10A has a half length a. Writing z=(x+iy)/a the index profile is given by Equation 7:

$$n = {n}_{0} max ( \frac{\sqrt{\vert 1 + {w}^{4} \vert}}{1 + {\vert w \vert}^{4}} , \frac{1}{2} ) , w = \sqrt{- i} cn [ K ( \frac{1}{2} ) ( z \sqrt{\frac{i}{2}} - 1 ) \vert 1 / 2 ] \qquad ( 7 )$$

In terms of the Jacobi elliptic function cn and the complete elliptic integral of the first kind K. The refractive index of the cell is depicted in FIG. 7, according to Equation 7. It should be noted that fabricated unit cells often don't take on the idealized index profiles as prescribed in the equations. However, the variations in fabrication do not detract from the working principle of the light propagation through unit cells and the focusing of light therein. Limitations deriving from fabrication techniques should not be considered a limiting factor in optimizing unit cells for light propagation. Indeed, index profile dispersion may arise and even enhance the functionality of final device.

Light propagation in the waveguide is governed by the Helmholtz Equation 8:

$$( {\partial }_{x}^{2} + {\partial }_{y}^{2} + {n}^{2} {k}^{2} ) E = δ ( x - {x}_{0} ) δ ( y - {y}_{0} ) . \qquad ( 8 )$$

Here x₀ and y₀ denote the coordinates of the point of emission and n describes the refractive index profile illustrated in FIG. 10A. In this embodiment, a series of unit cells are connected in a grid or array. FIG. 10B shows what the refractive index profile of FIG. 10A does: it focuses light rays coming from any point (in a region for which n>n₀/2) to a regular pattern of points.

Changing the Path of Light—Plurality of Unit Cells with Reflectors

A plurality of unit cells can be connected to form a linear waveguide or a planar waveguide which directs light in a particular direction. A linear waveguide is one where light is directed in one direction. The direction light propagating in linear waveguides can be changed using a reflector. As used herein, where the direction of light propagating in a waveguide has been changed by a reflector is referred to as a “linear waveguide”, in some embodiments. A plurality of reflectors facilitates the changing of the direction of light propagation. The positioning of unit cells, comprised within arrays and the reflectors is customizable to achieve the desired light propagation requirements. In some embodiments “linear waveguides” and “planar waveguides” are interchangeable.

In various embodiments the terms “array”, “grid”, “tiling” and “tessellation” are used interchangeably. In various embodiments each array is comprised within an optical bus. A multi-core processor utilizes an optical bus as a means of communication between core processors. In some embodiments, the terms “processor core”, “processor” and “core” are used interchangeably. As will become apparent the optical bus and various systems that it is connected to is modular and can be customized according to the specifications of the task and/or user.

In one embodiment the array of unit cells are tessellated. In another embodiment, the plurality of unit cells is partly tessellated. As shown herein, the present invention is not limited to a particular tiling, but rather any tiling that performs the functions detailed herein are within the scope of the invention. Therefore, a particular cell shape, combination of shapes and/or different tiling of that shape are considered as embodiments this invention. In positioning the plurality of unit cells to form an array, any one unit cell is connected to at least one other unit cell. In one embodiment there are no gaps in-between unit cells. In another embodiment there are gaps between unit cells. For example, a tessellation of square unit cells may not form any gaps, whereas tiling of higher-order polygons may require gaps in order to form the array. In one embodiment the unit cells are connected in a seamless or continuous manner. For example, the refractive index at the boundary between one unit cell and its neighboring unit cell is about the same or identical.

“Reflectors” are used to change the direction of light transmission. In some embodiments the terms “mirrors” and “reflectors” are used interchangeably. The reflectors themselves can take on any shape or form that is compatible within the system. Typically, and in some embodiments, the reflector is a Bragg mirror. In one embodiment, the reflector shape is selected from any of the following shapes: flat, concave and convex. Bragg mirrors are also referred to as “dielectric mirrors”. In one embodiment, the reflector comprises any of the following selected from: at least one layer of a dielectric material, at least one optical coating, at least one metallic coating, at least one dielectric coating, at least one high reflection coating or any combinations thereof. Non-limiting examples of metallic coatings include: gold, silver and aluminum.

In one embodiment a plurality of reflectors is used to redirect light any number of times. In one embodiment, at least one reflector is used to change the path of light in a planar waveguide. In one embodiment, there is no energy loss upon reflection of light. In some embodiments the reflector is about 100% efficient at reflecting light. In some embodiments the reflector is about 99.9% efficient at reflecting light. The reflection specification of different materials is considered for different wavelengths and frequency bandwidths. As such, some materials are considered more suitable and optimized if the system requires a particular bandwidth of transmission to be used. A user can select which material and bandwidth is required to carry out a particular function, such as reflection or transmission, all according to the specification and requirements of the planar waveguide and user. Typically, the planar waveguides described herein utilize infrared light, as such, reflectors are selected according to their compatibility with this frequency range.

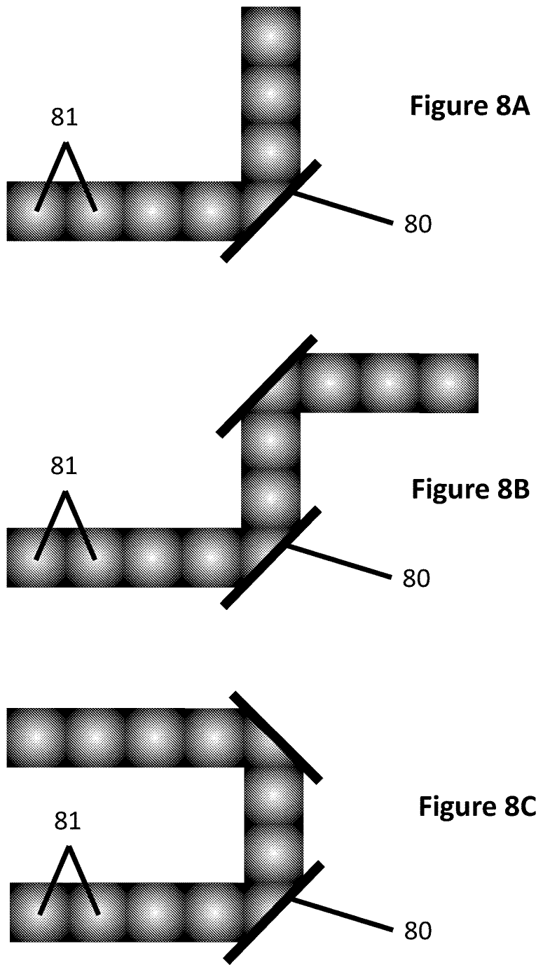

FIG. 8 shows some examples of a plurality of unit cells 81 that are connected to one another and wherein a reflector 80 is positioned to redirect light transmission. The unit cells are shown in greyscale denoting a varied refractive index profile. The particular form of the greyscale depicted in FIG. 8 is for the purposes of example alone; as with other figures. FIG. 8A demonstrates an embodiment where a reflector 80 is positioned in such a way as to change the transmission of light propagation by 90 degrees. FIG. 8B demonstrates an embodiment where a plurality of unit cells 81 are connected to one another and where two reflectors 80 are positioned in such a way as to change the direction of light transmission by 90 degrees twice; wherein the initial direction of light transmission and the final direction of light transmission are parallel. FIG. 8C demonstrates an embodiment where a plurality of unit cells 81 are connected to one another and where three reflectors 80 are positioned in such a way as to change the direction of light transmission by 90 degrees three times; wherein the initial direction of light transmission and the final direction of light transmission are parallel but wherein the initial and final directions of light are in opposite directions.

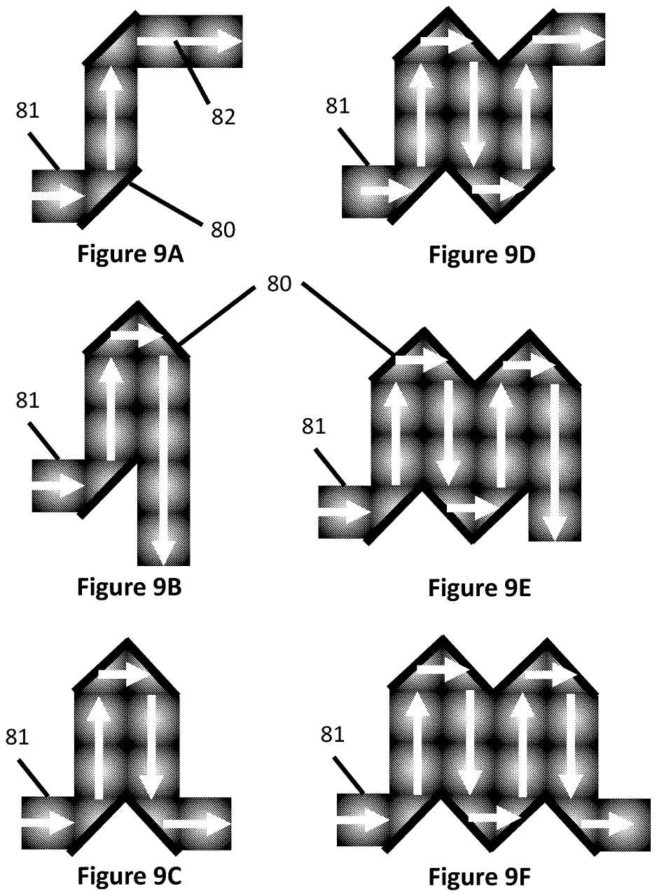

FIG. 9 shows different embodiments of a plurality of unit cells 81 connected together with reflectors 80 changing the direction of light propagation 82. In these embodiments, the reflectors change the direction of light propagation by 90 degrees. Nonetheless, the angle to which a reflector changes the direction of propagating light can be selected according to the requirements of the user. FIG. 9A shows a similar configuration as FIG. 8B wherein a plurality of unit cells 81 are connected to one another and wherein reflectors 80 change the direction of light propagation 82. The other figures can be understood in a similar manner: FIG. 9B comprises a plurality of unit cells 81 and three reflectors 80. FIG. 9C comprises a plurality of unit cells 81 and four reflectors 80. FIG. 9D comprises a plurality of unit cells 81 and six reflectors 80. FIG. 9E comprises a plurality of unit cells 81 and seven reflectors 80. FIG. 9F comprises a plurality of unit cells 81 and eight reflectors 80. Each figure shows how the light propagation path 82 changes when incident on a reflector 80. As evident in FIG. 9, a plurality of connected unit cells can be constructed together with a plurality of reflectors to change the direction of light propagation any number of times, in a planar waveguide. As will become apparent, the addition of reflectors in this manner creates a zigzag pattern of reflectors. As such, any number of reflectors can be added to increase the length of light propagation. Also, this configuration ensures a maximal packing of unit cells and highest density of light propagation.

FIG. 10 shows an idealized schema of a planar waveguide 90 comprised of a plurality of unit cells 81, with a varied refractive index profile (greyscale), forming an array of unit cells. The planar waveguide 90 is confined between a first reflector 92 and a second reflector 93 and is open on two other sides (i.e., where no reflection occurs). Although the first 92 and second 93 reflectors are each comprised of a plurality of perpendicular reflectors the reflectors need not be this specific shape. In some embodiments any periodic reflector shape can be used as the reflectors in the planar waveguide 90. In some embodiments the periodic reflector shape is in the form of a zigzag. In some embodiments the periodic reflector shape is in the form of a sinusoid. The first 92 and second 93 reflectors are depicted as zigzags with reflectors periodically alternating direction by 90 degree angles, in FIG. 10A. In another embodiment the periodic reflector shape is different for the first 92 and second 93 reflectors.

FIG. 10B depicts light rays 94 propagating through the array with the refractive index profile of FIG. 10A. The light rays 94 are shown being reflected by the first 92 and second 93 reflectors which are zig-zag in shape. The planar waveguide focuses light rays 94 coming from any point to a regular pattern of points or foci 95. The planar waveguide focuses light rays 94 coming from any point (in a region for which n>n₀/2) to a regular pattern of points or foci 95. For example, if a light source illuminated any one of the foci 95 it would generate identical foci 95 at other locations across the planar waveguide. This is a form of self-imaging which is well maintained across the planar waveguide 90. It is noted that although the planar waveguide relates to light propagation, it analogously relates to energy and electric field propagation. As such, these terms can be considered synonymously when considering the functioning and operation of the planar waveguide. In some embodiments the light rays 94 do not form uniform (i.e., perfectly spherical, circular or elliptical) shapes. Typically, and in some embodiments, the foci 95 are elongated. This is due to deviations in the tiling of neighboring unit cells and the inability to form perfect structures. Depending on the nature of the illumination of the light, the foci 95 can change position. Generally, shorter wavelengths will produce foci that are spatially closer together. Furthermore, when the position of the light-injection point is varied, the position and/or the shape of the foci in different unit cells will change. When light is injected at certain positions within the unit cell the elongation of the foci will change. In some embodiments, one unit cell will comprise one focus point 95. In some embodiments one unit cell comprises at least one focus point 95.

In one embodiment the foci 95 are separated by at least half a wavelength. In one embodiment the foci 95 are separated by at least one wavelength. In one embodiment the foci 95 are separated by n wavelengths.

In some embodiments, a plurality of emitters and detectors are incorporated within the planar waveguide. Each of the illumination ports of the array is implemented as dual-function illumination port that operates either as a light emitter or a light detector (e.g., photodetector) depending on the bias applied, as noted above. When the optically active structure of the illumination port is forward biased, it functions as a LED and when reverse biased, it acts a photodetector, in some embodiments. In various embodiments devices that send signals are referred to herein as ‘emitters’ or ‘transmitters’ and are understood interchangeably. In some embodiments, devices that receive signals are referred to herein as ‘detectors’, ‘receivers’ or ‘sensors’ and are understood interchangeably.

In some embodiments the photodetector is selected from any of the following: photodiodes, phototransistors, charge-coupled devices (CCDs), avalanche photodiodes (APDs), image sensors, complementary metal-oxide-semiconductor (CMOS), photoresistors and photoconductors or any combinations thereof.

In some embodiments the optical bus described herein is comprised within a multi-core processor. A core-processor refers to an individual processing unit in a computer's central processing unit (CPU) which performs operations to execute instructions in a computer program. Generally, processors operate independently. Multi-core processors are connected through a shared bus or other means of connection which allows the cores to communicate with one another and share resources or information such as memory and data.

In one embodiment, a multi-core processor comprises a plurality of core processors and the optical bus as described herein. In some embodiments between 2 and 10,000 core-processors are comprised in a multi-core processor. In some embodiments between 2 and 1,000 core-processors are comprised in a multi-core processor. In some embodiments between 2 and 100 core-processors are comprised in a multi-core processor. In some embodiments between 100 and 500 core-processors are comprised in a multi-core processor. In some embodiments between 500 and 1000 core-processors are comprised in a multi-core processor. In some embodiments between 1000 and 5000 core-processors are comprised in a multi-core processor. In some embodiments between 5,000 and 10,000 core-processors are comprised in a multi-core processor. In some embodiments between 2 and 100,000 core-processors are comprised in a multi-core processor. In principle the number of core processors comprised within a multi-core processor is non-limiting when utilizing the optical bus described herein.

In some embodiments, multi-core processors are compatible with any of the following non-limiting architectures: multi-chip package (MCP), System-on Chip (SoC) or Non-Uniform Memory Access (NUMA). In some embodiments the optical bus is comprised within an integrated circuit. In some embodiments the term “integrated circuit” (IC) and “multi-core processors” are used interchangeably.

In some embodiments, the core-processor or multi-core processors comprises any of the following components: an optical-bus, an arithmetic logic unit (ALU), a control unit (CU), central processing unit (CPU), registers, cache, decode unit, input/output (I/O) interfaces and interconnects. “Interconnects” refer to a component used for communication between cores in a multi-core processor. In some embodiments the terms “interconnect”, “optical bus” or “bus” are used interchangeably. In some embodiments these interconnects comprise a material that directs light. For example, interconnects which direct light can be comprised of or consist of optic fibers. Non-limiting examples of materials used for interconnects or optic fibers include: silica, plastic, polymer, glass, doped materials, single-mode fibers, multi-mode fibers, graded-index fibers, chalcogenides, etc. In one embodiment, interconnects comprise waveguides. In some embodiments, interconnects comprise at least one metal. Non-limiting examples of metals used for interconnects include: copper, gold, aluminum, silver, platinum, tungsten, palladium, rhodium, nickel, titanium, tantalum, etc. In some embodiments, interconnects comprise at least one metal alloy.

In various embodiments, a plurality of core processors are connected in a system comprising an optical bus. In various embodiments, a plurality of multi-core processors are connected in a system comprising an optical bus. As understood herein, the optical bus can connect any number of individual core-processors, a plurality of core processors, multi-core processors or any combination thereof. Therefore, when describing the connectivity of more than one core processor, the principles of connecting a plurality of core-processors, or multi-core processors, via optical buses, can be applied.

In some embodiments multi-core processors comprise a plurality of core processors. In some embodiments the invention provides a system for connecting multi-core processes, the system comprising:
a plurality of multi-core processors, wherein each multi-core processor comprises a plurality of core processors;
   an optical bus comprising a plurality of optical communication channels, each configured to transmit optical signals;
   a first set of transceivers corresponding with each multi-core processor, configured to convert electrical signals from respective multi-core processors into optical signals for transmission via the optical bus; and
   a second set of transceivers corresponding with each multi-core processor, configured to convert optical signals received from the optical bus into electrical signals for communication to the respective multi-core processors;

As understood herein, and in various embodiments, the optical bus is configured to transmit optical signals along the optical bus for the purpose of interconnecting multiple devices (plurality of core processors, multi-core processors, etc.) or components within a network. The use of transmitters and receivers (together ‘transceivers’) are for the purpose of sending and receiving signals throughout the system. Transferring data in the form of optical and electric signals, and conversion of those signals throughout the system, enables seamless data transfer. “Communication channels” refer to any channel that can send and/or receive a signal e.g., an optical, electrical signal, etc. Therefore, ‘transmission channels’ are also referred to herein, as communication channels, and vice versa. In various embodiments, the term communication ‘channel’ is understood as a communication ‘path’,

In some embodiments the system further comprises at least one controller configured to manage data traffic via the optical bus. In some embodiments the controller is configured to manage data traffic across the system as a whole. Data management can include, but is not limited to, actions and decisions undertaken by the controller to ensure efficient and effective handling of data with the network or system. Examples include, but are not limited to: traffic prioritization, bandwidth allocation, quality control, monitoring, analysis, load balancing, dynamic routing, security and access control or any combination thereof.

In various embodiments the controller is configured to allocate a bandwidth to the plurality of multi-core processors. Bandwidth allocation may be associated with processing, transmission, computation requirements or a combination thereof. Data traffic through the system can take on any form, for example, selected from, but not limited to: integer, floating-point, character, strings, Boolean, data arrays, pointers, structure elements, numbers, voids, etc. In one embodiment the data corresponds to an electric signal, an optic signal, or a combination thereof. As described here, optical signals have corresponding electrical signals, and vice versa, and transferred through the system via transceivers.

Although optical buses, as used in multi-core processors described in various embodiments herein, utilize light, these optical buses and resulting multi-core processors are compatible with all standard processors. In various embodiments the optical bus is compatible with standard silicon and gallium arsenide ICs. In one embodiment a multi-core processor comprises both standard processor cores and ones based on planar waveguides. As such, the multi-core processors comprising optical buses uses both optical and electric signals simultaneously, in one embodiment,

Transfer of information and reading of signals is an important feature of integrated circuits. As such, the integrated circuits disclosed herein can further comprise any of the following to read signals: amplifiers, analog-to-digital converters (ADC), comparators and sensors.

### Methods of Fabrication

Fabrication methods are now disclosed detailing the fabrication of unit cells, arrays of unit cells, the incorporation of Bragg mirrors, etc. Primarily, to achieve a desirable refractive index profile for unit cells the thickness or height of the dielectric material is varied across the cell. In some embodiments the terms “thickness” and “height” in reference to structures such as the unit cell and layers in the fabrication process (e.g., silicon layer, silicon oxide layer, photoresist layer), are used interchangeably. Examples of materials suitable for the unit cell have already been disclosed herein. A primary dielectric material for the unit cell is that which is silicon-based.

There are several fabrication methods disclosed that obtain a thickness profile of a dielectric material that varies across one unit cell. In one embodiment thermal oxidation is used to define the thickness profile of unit cells in an array, forming planar waveguides. In some embodiments, the unit cell is not directly exposed to etching processes. In some embodiments, etching processes define the topography of the unit cell and the subsequent array. These methods apply to both individual unit cells and, by extension, an array of unit cells forming an array or grid.

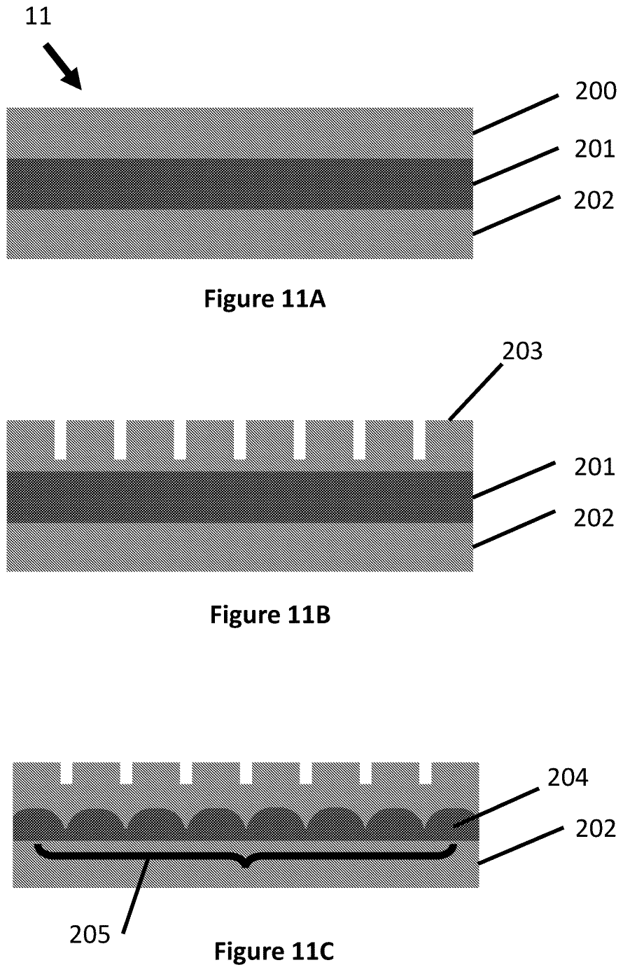

Preparing waveguides where the unit cell itself does not undergo etching is considered below. A schematic representation of this process is shown in FIG. 11. Several embodiments of various stages of the thermal oxidation fabrication process are presented herein.

In some embodiments a silicon substrate 201 is provided with a buried oxide 202 (~3 μm) underneath e.g., a silicon on insulator (SOI) wafer 11. In one embodiment an oxide 200 is grown on the silicon substrate 201, to obtain a SiOₓ/Si/SiOₓ sandwich 11. In some embodiments silicon oxide refers to silicon dioxide. In some embodiments the upper layer 200 is grown by thermal oxide deposition.

Photolithography processes are subsequently used to pattern an array shape 203 on the sandwich 11, leaving part of the upper oxide exposed for etching. For example, a photoresist is exposed and developed, leaving an array of squares with gaps exposed to the silicon oxide upper layer 200. The sandwich 11 comprising a photolithography pattern (with resist) is etched to etch the upper oxide 200 such that part of the substrate comprises a thick upper layer oxide and a thin upper layer oxide, as represented by steps in the upper layer 203 in FIG. 11B. For example, the thickness of part of the upper layer 203 is 500 nm whilst the thinner parts of the upper layer are 50 nm in thickness. The patterned upper layer 203 thus contains thick and thin silicon oxide portions according to the pre-defined photolithography pattern. Although FIG. 11 shows a cross-section of such a stack, the principle is extended to 2- and 3-dimensions.

Thermal oxidation is subsequently employed on the whole sandwich of FIG. 11B to define an array 205 of unit cells 204. In this step, oxide growth penetrates the silicon layer 201. Where the patterned upper layer 203 is thinner, oxide penetration into the silicon layer 201 which undergoes thermal oxidation is more pronounced i.e., the oxide in the upper layer 203 and the under layer 202 are closer together. Where the silicon layer 201 is more buried under the upper oxide layer 203 penetration into the silicon layer 201 is lower. In this sense, the patterned upper layer 203 assists in defining the topography of the final silicon layer comprising an array 205 of unit cells 204. In some embodiments, the thickness of the upper oxide layer after etching, as well as the thermal oxidation exposure time and intensity (and concentration) helps to optimize and define the final shape of the array 205 and unit cells 204.

In some embodiments overexpose or under-exposure at the stage of etching or thermal oxidation assists in providing smooth coupling between unit cells 204 in the array 205. In some embodiments, an additional cladding layer is used on top of the upper layer 203. In some embodiments, cladding can comprise any material that is similar in refractive index to the upper layer 203.

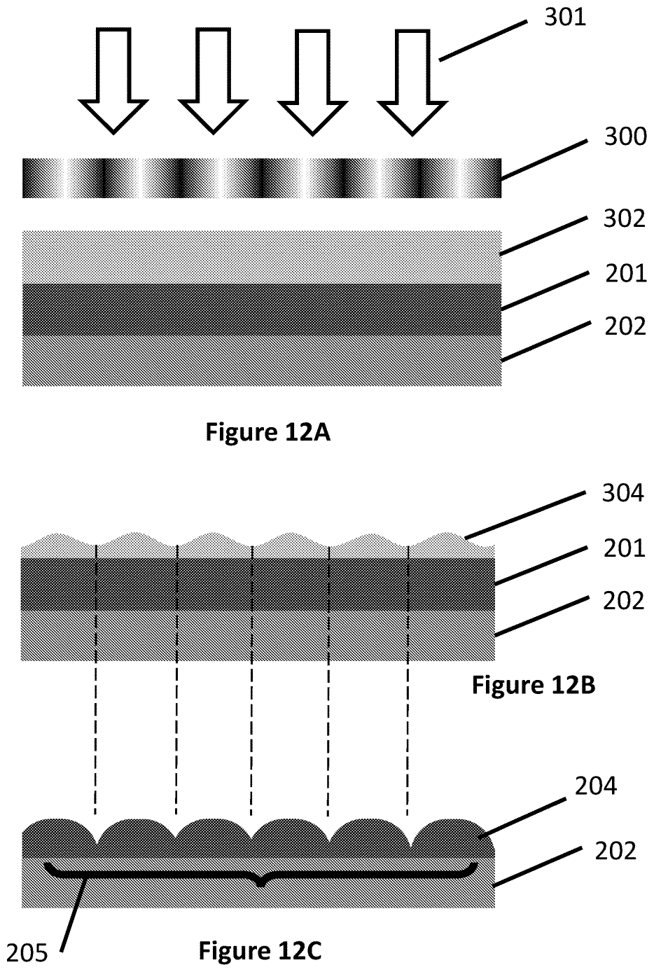

FIG. 12A shows another embodiment of a method of fabricating an array of unit cells in an array, wherein a grayscale photomask 300 is employed to obtain the height profile required for the unit cells in a planar waveguide. Light 301 is exposed through a grayscale photomask 300 onto a photo-resist 302 on a silicon layer 201 on a buried oxide 202 to eventually define regions of varying height on the silicon layer 201. The grayscale photoresist 300 can comprise any array structure, which correlates to the final structure of the desired unit cell and array. In some embodiments, the photo-resist layer 302 is post-baked and/or pre-baked. The method further comprises developing the photoresist, as is known in the art, which will differ for each photo-resist e.g., for positive versus negative photoresists. After photolithography patterning, and in some embodiments, thermal oxidation of the whole stack (buried oxide, silicon layer, patterned photoresist layer), produces the desired unit cells 204 profile and subsequent array 205.

In another embodiment, due to the sinusoidal height profile of the photoresist 304 (the example of which is shown in FIG. 12B), etching of the patterned photo-resist 304 together with the silicon layer 201 creates a height profile across unit cells 204 within an array 205. The dotted lines connecting FIG. 12B to 12C show that etching where the photoresist is thinner (i.e., a trough in the sinusoid) corresponds to a smaller thickness in the silicon layer 201 (i.e., a trough). In contrast, where the photoresist 304 is thicker (i.e., peak in the sinusoid) the etching penetration is lower, which corresponds to a peak height of unit cells 204 in the silicon layer 201.

In some embodiments, thermal oxidation and etching is carried out together to achieve the height profile across unit cells 204 within an array 205. In some embodiments only thermal oxidation is used on the patterned photoresist 304. In other embodiments only etching is used on the patterned photoresist 304.

In another embodiment, grayscale direct laser writing is employed to produce the patterned photoresist 304 shape shown in FIG. 12B. In another embodiment, the grayscale photomask 300 is replaced with a non-grayscale photomask i.e., a regular photo mask. With a non-grayscale photomask, over-exposure or under-exposure of the photoresist 302 creates the pattern on the patterned photoresist 304. Overexposure and underexposure depends on whether the photoresist is a positive or negative photoresist, both of which are compatible and considered as embodiments of the present method of fabrication. Over- and under-exposure provides the edge-effects required to provide the sinusoidal pattern of the patterned photoresist 304.

Once the array 205 of unit cells 204 is fabricated (as seen in FIG. 12C) any remaining photoresist is removed, in some embodiments. Otherwise, additional layers of dielectric material are deposited onto the array 205 in methods known in nanofabrication. For example, spin coating, thermal deposition, vapor deposition is used to deposit a layer on top of the array 205 to act as cladding or an encapsulation material.

In some embodiments grayscale electron beam lithography (EBL) is used in the same manner as described herein regarding other greyscale lithographic processes, to generate the structural profile of the unit cells and subsequent array of unit cells.

### Methods of Operation—Planar Waveguides and Multi-Core Processors

It should be appreciated that many possible light propagation geometries exist that provide optically-connected focal group sets enabling emission at any focal point and light convergence at all remaining focal points. The same operation principles as described hereinabove for the ring-shaped and square-shaped waveguides are utilized for the present application of planar waveguides which comprise an array of unit cells. Namely, utilizing an illumination or light-management system together with a planar waveguide to transfer information, in some embodiments.

Furthermore, in a certain embodiment the light propagation layer is divided by an additional non-propagation layer to form a multi-layer planar waveguide. Thickness profile of the two propagation layers is determined by extending the methods described here within as is known to those skilled in the art.

An optical bus optically connects more than one processor core through a plurality of illumination port arrays; each array being dedicated to its respective processor core. Each illumination port of each array is a member of its own port set and is embedded into a propagation layer at each focal point or embedded into one of non-propagation layers and directed to the focal points in the light-propagation layer in another embodiment.

In some embodiments, a plurality of emitters and detectors are incorporated. Each of the illumination ports of array is implemented as dual-function illumination port that operates either as a light emitter or a light detector depending on the voltaic bias applied, as noted above. When the optically active structure of the illumination port is forward biased, it functions as a LED and when reverse biased, it acts a photodetector, in some embodiments.

In certain embodiment, a first set of ports operate at a first wavelength and a second set of ports at a different wavelength. In other embodiments, the ports operate in the infrared frequency range.

Biasing is managed by a light management system of switching electronics disposed in one or more of the cores, other processing units, or both; depending on the embodiment. The light management system is in communication with processor core circuitry and is operative in accordance with data transmission requirements between the cores. Temporal data is optically transmitted from any one of the illumination ports activated as light emitters and received by corresponding ports activated as photodetectors associated with other cores as guaranteed by the design of propagation layer.

Since each array is formed from one illumination port from each respective port set, the number of ports in each array represents the number of discrete, data transmission paths available for optical data transmission. The optical bus advantageously increases data transfer rate between cores by a factor of 1000. Furthermore, better connectivity between processor cores can increase computational power, reduce power consumption, and increase battery life of mobile devices.

In one embodiment the multi-core processor comprises a plurality of core processors and an optical bus.

In one embodiment, a method of operating such a multi-core processor comprises:
providing a multi-core processor comprising a plurality of core processors and an optical bus;
operating the light-management system for the transmission of light from a port of one core processor in a plurality of core processors, which is received at the ports of other core processors in said plurality of core processors;
said transmission of light comprises a sequence of light pulses that the planar waveguide directs to said ports of other core processors; and
the light management system converts the sequence of light pulses into electric signals.

In effect a plurality of core processors communicates with one another via the optical bus. Any signal (transmitted and/or received) can be transferred from one core processor to another. In some embodiments “emitting”, “emission” and “transmission” are used interchangeably and refer to a signal emanating from one location towards another. Conversely, terms such as “receiver”, “receiving”, “detector” or “detection” are used interchangeably in reference to receiving a signal that was emitted from a different location.

In some embodiments, the plurality of core processors are all in communication with the optical bus to transfer data between core processors in a multi-processor network. “Communication” refers to any type of transfer of information between core processors or elements within core processors, in any form, for example: light, electromagnetic waves, optical, electric, charge transfer, data, memory, energy, magnetic, etc.

The light management system is configured to switch the state of ports. In some embodiments, the port is in an emission state (i.e., an emitter) whereas in other embodiments the port is in a receiving state (i.e., a detector). Thus, a port can be an emitter or a receiver. In some embodiments the port can be an emitter and receiver simultaneously. A receiver is otherwise referred to as a “detector” or “photodetector” throughout.

The manner in which data is transmitted and received in core processors is typically by electrical signals. Optical buses allow light signals to be a medium via which information can be communicated between core processors. Since the planar waveguide described herein can be constructed of an array of any size, the number of core processors in a multi-core processor is limitless due to nature of the optical bus. In any physical system, there will be limitations since the transmission efficiency is never exactly 100%. However, optical transmission efficiency is almost 100%, thus facilitating a near limitless number of processor cores for multi-core processing.

The switching of signals from one state to another is according to a particular task that requires executing. To communicate between processor cores, the signal can take on the form of a series of light pulses at an illumination port which is received at a receiving port. Ports can both transmit and receive a signal, depending on the state that they are in. The frequency, wavelength, amplitude, waveform and velocity (or any wave property) of that light signal is selected according to the requirements of the operator of the light system or the computer program that is being executed. Thus, in various embodiments, the switching of ports from one state to another (for example, on/off or transmission/receiving) generally refers to any signal that is transferred from one processor to another via the optical bus. In one embodiment, the signal comprises light pulses. In some embodiments, the light signal is a digital signal. In some embodiments, the light signal is converted to an electric signal. Typically, converting optical to electric signals is carried out by a photodetector, various examples of which are disclosed throughout.

Due to the modular structure of planar waveguides consisting of unit cells the optical bus is scalable to an in-principle unlimited number of cores. In practice, optical losses will limit the number of processor cores, but that limit is significantly larger in the present invention in comparison with the typical number of cores currently used in industry.

In one embodiment, the term “a” or “one” or “an” refers to at least one. In one embodiment the phrase “two or more” may be of any denomination, which will suit a particular purpose. In one embodiment, “about” or “approximately” may comprise a deviance from the indicated term of +1%, or in some embodiments, −1%, or in some embodiments, ±2.5%, or in some embodiments, ±5%, or in some embodiments, ±7.5%, or in some embodiments, ±10%, or in some embodiments, ±15%, or in some embodiments, ±20%, or in some embodiments, ±25%.

### EXAMPLES

### Example 1

### Simulation: Transformation Optics for Optical On-Chip Communication

JCM Wave performed 2D computer simulations to test the performance of transformation optics for on-chip optical communication. Rectangular arrays of 8 times 8 and also 7 times 7 quadratic cells were investigated. Each cell was 30 microns long and wide. Light of a free-space wavelength of 1 micron or 1.5 microns was assumed to be injected by a point source at various positions.

The simulation found that:
precise focusing occurs for any point in about 50% of the total area, despite the fact that the implemented profile is not perfect;
the foci are elongated, about 1 micron wide and 5 microns long;
only one polarization of light is focused, light of the other polarization is rapidly diffused in the waveguide;
a detuning of 5 nm from the free-space wavelength the waveguides are designed for is well-tolerated. The waveguide still functions for 10 nm detuning. For higher detuning, it loses its functionality.

Furthermore, an estimation of absorption assuming a 1 cm² optical chip with 10 times 10 cells (amounting to 10 cm total propagation distance) was determined. In this case an extinction coefficient of 2×10⁻⁶ does not lead to significant losses, which requires an operating wavelength of 1.17 microns or longer for Silicon.

From these results it was concluded that:
from the focusing properties follows that a 1 cm² optical chip can support up to 10 million optical ports;
light sources should have an emission bandwidth (full width at half maximum) of 10 nm for safe propagation;
Sources/detectors should function for wavelengths not smaller than 1.17 microns.

Those skilled in the art to which this invention pertains will readily appreciate that numerous changes, variations, and modifications can be made without departing from the scope of the presently disclosed subject matter, mutatis mutandis.

1. An optical bus comprising:
a planar waveguide comprising a light-propagating layer comprising a plurality of unit cells, wherein said unit cells have a non-uniform refractive index profile;
a set of illumination ports configured to direct light into said light-propagating layer;
a plurality of reflectors configured to change the direction of light propagating in the light-propagating layer at least once; and
a light management system configured to selectively activate one or more illumination ports of a set of light emitters and simultaneously activate one or more illumination ports of a set of photodetectors.

2. The optical bus of claim 1 wherein said plurality of unit cells forms an array.

3. The optical bus of claim 1 wherein said planar waveguide further comprises an upper layer above and a lower layer below said light-propagating layer.

4. The optical bus of claim 3 wherein said upper layer and said lower layer have a lower refractive index than the refractive index of the light-propagating layer.

5. The optical bus of claim 1 wherein said light-propagating layer comprises silicon.

6. The optical bus of claim 4 wherein said upper layer and said lower layer comprise silica.

7. The optical bus of claim 1 wherein said refractive index profile is the same in each of said unit cells.

8. The optical bus of claim 1 wherein said refractive index profile is not the same in each of said unit cells within said array of cells.

9. The optical bus of claim 1 wherein said refractive index is dictated by the thickness of the light-propagating layer.

10. The optical bus of claim 1 wherein each unit cell of said plurality of unit cells have a refractive index of between 1.5 and 3.0.

11. The optical bus of claim 1 wherein the shape of said unit cell is selected from a list comprising: square, rectangle, circle, trapezoid, rhombus, parallelogram, triangle, quadrilateral, pentagon, hexagon, heptagon, octagon, nonagon, decagon or any combination thereof.

12. The optical bus of claim 1 wherein said plurality of reflectors are Bragg mirrors.

13. The optical bus of claim 1 wherein said plurality of reflectors form at least two zig-zag shaped reflectors at opposite sides of the planar waveguide and configured to direct light through said plurality of unit cells.

14. The optical bus of claim 1 wherein said set of illumination ports are positioned within said light-propagating layer.

15. The optical bus of claim 3 wherein said set of illumination ports is positioned within said upper layer or lower layer, or within said upper layer and said lower layer.

16. The optical bus of claim 1 wherein said set of illumination ports are configured to focus light emanating from any light port of the set onto a plurality of remaining ports of the set.

17. The optical bus of claim 1 wherein the size of said unit cell is at least one order of magnitude larger than the wavelength of said light.

18. (canceled)

19. The optical bus of claim 1 wherein said light comprises more than one frequency transmission.

20. A system connecting multi-core processors, said system comprising:
a plurality of multi-core processors, wherein each multi-core processor comprises a plurality of core processors; and
the optical bus of claim 1 configured to transmit optical signals between said plurality of multi-core processors.

21-30. (canceled)

31. A method of operating a system connecting multi-core processors, said method comprising:
providing the system of claim 20;
operating the light management system for the transmission of light from a port of one core processor in a plurality of core processors, which is received at the ports of other core processors in said plurality of core processors;
said transmission of light comprises a sequence of light pulses that the planar waveguide directs to said ports of other core processors; and
the light management system converts the sequence of light pulses into electric signals.
